(19) United States
(12) Patent Application Publication
(10) Pub. No.: US 2019/0302881 A1
(43) Pub. Date: Oct. 3, 2019

(54) DISPLAY DEVICE AND METHODS OF OPERATION

(71) Applicant: OmniVision Technologies, Inc., Santa Clara, CA (US)

(72) Inventors: Anson Chan, San Jose, CA (US); Lequn Liu, San Jose, CA (US)

(21) Appl. No.: 15/940,784

(22) Filed: Mar. 29, 2018

(51) Int. Cl. G06F 3/01; G02B 27/01

(52) U.S. Cl. CPC G06F 3/013; G06T 19/006; G02B 27/0176; G02B 27/0172

(57) ABSTRACT

A display system includes a display positioned to show images to a user, and a sensor positioned to monitor a gaze location of an eye of the user. A controller is coupled to the display and the sensor, and the controller includes logic that causes the display system to perform operations. For example, the controller may receive the gaze location information from the sensor, and determine the gaze location of the eye. First resolution image data is output to the display for a first region in the images. Second resolution image data is output to the display for a second region in the images. And third resolution image data is output to the display for a third region in the images.

### TECHNICAL FIELD

This disclosure relates generally to displays, and in particular but not exclusively, relates to eye tracking.

### BACKGROUND INFORMATION

Virtual reality (VR) is a computer-simulated experience that reproduces lifelike immersion. Current VR experiences generally utilize a projected environment in front of the user's face. In some situations the VR experience may also include sonic immersion as well, such as through the use of headphones. The user may be able to look around or move in the simulated environment using a user interface. Vibrating the user interface or providing resistance to the controls may sometimes supply interaction with the environment.

Generally the performance requirements for the VR headset systems are more stringent than the display systems of cellphones, tablets, and televisions. This is in part due to the eye of the user being very close to the display screen during operation, and the frequency that the human eye can process images.

### BRIEF DESCRIPTION OF THE DRAWINGS

Non-limiting and non-exhaustive examples of the invention are described with reference to the following figures, wherein like reference numerals refer to like parts throughout the various views unless otherwise specified.

FIG. 1A depicts an example head-mounted device, in accordance with the teachings of the present disclosure.

FIG. 1B depicts a cross sectional view of the example head-mounted device of FIG. 1A, in accordance with the teachings of the present disclosure.

FIGS. 2A & 2B illustrate examples of providing image data to a display in a manner that reduces the required bandwidth, in accordance with the teachings of the present disclosure.

FIG. 3 shows an example method of operating a head-mounted device, in accordance with the teachings of the present disclosure.

FIG. 4 shows an example method of operating a head-mounted device, in accordance with the teachings of the present disclosure.

FIG. 5 shows an example method of operating a head-mounted device, in accordance with the teachings of the present disclosure.

FIG. 6 shows an example method of operating a head-mounted device, in accordance with the teachings of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Examples of an apparatus, system, and method relating to a display device are described herein. In the following description, numerous specific details are set forth to provide a thorough understanding of the examples. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

The performance requirements for virtual reality (VR) or augmented reality (AR) headset systems are more stringent than the display systems of cellphones, tablets, and televisions. One critical performance requirement is high resolution. Generally, a pixel density of ˜60 pixels/degree at the fovea is usually referred to as eye limiting resolution. For VR, each high resolution stereographic image runs twice, once per eye, to occupy most of the user's peripheral vision (e.g., vertical vision is ˜180 degrees, and horizontal vision is ˜135 degrees). In order to render high resolution images, a large set of image data may need to be provided from the processor/controller of the VR system to the VR display.

Another critical performance parameter is short latency. Long latency can cause the user to experience virtual reality sickness. In some VR embodiments, the ideal latency would be 7-15 milliseconds. A major component of this latency is the refresh rate of the display, which has been driven up to 120 Hz or even 240 Hz. The graphics processing unit (GPU) also needs to be more powerful to render frames more frequently. In some VR examples, in order to feel seamless, the frame rate needs to be at least 90 fps.

Accordingly, due to the large data set required, it is challenging for current graphic cards and displays to achieve at least 90 fps (frames per second), 120 Hz or greater refresh rate (for stereo 3D with over-1080p resolution), and wide field of view all at the same time. This disclosure describes a head-mounted device/system (and operational methods) to reduce the required bandwidth and achieve better latency without perceptible lose in image quality to the user.

The following description discusses the examples disclosed above, as well as other examples as they relate to the figures.

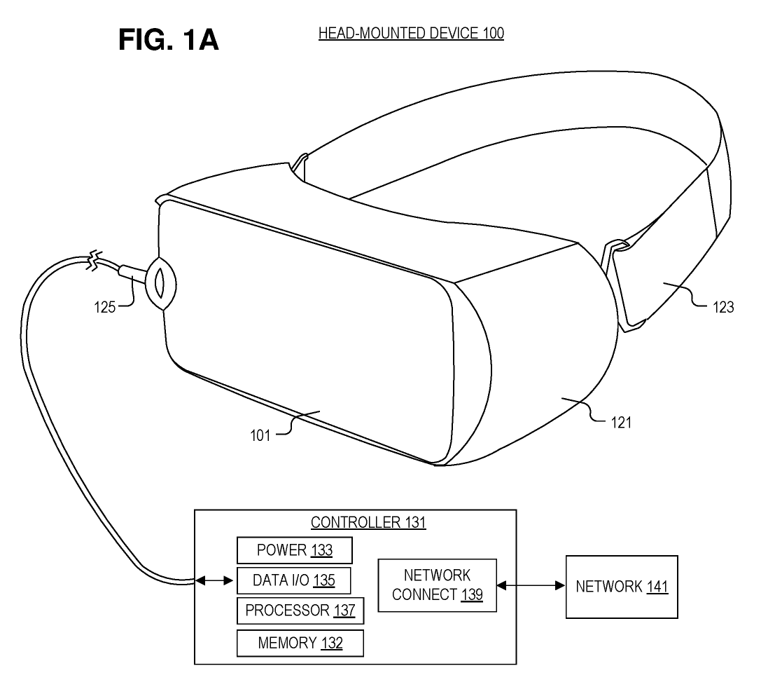

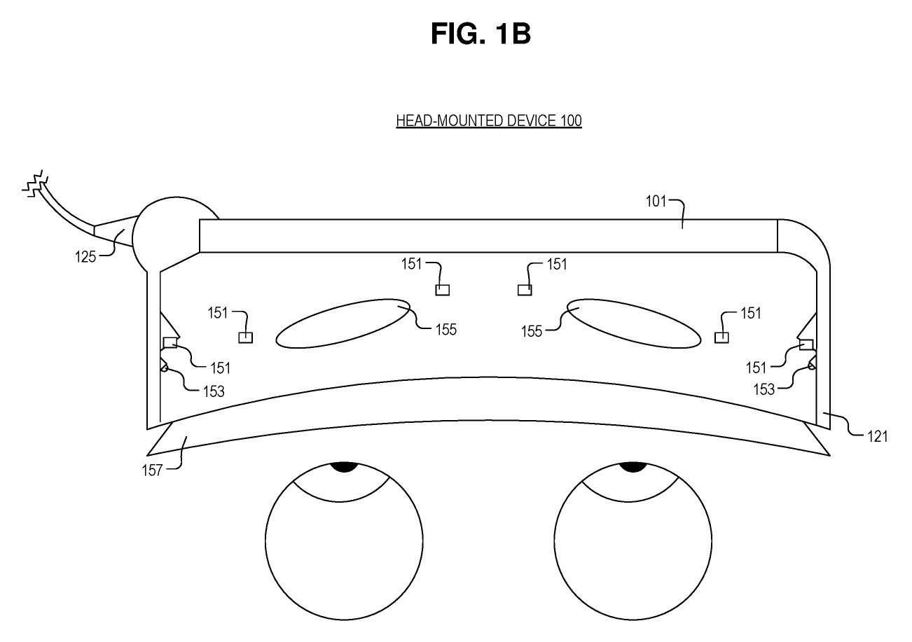

FIG. 1A depicts an example head-mounted device 100 including display 101, housing 121, strap 123, data/power connection 125, controller 131, and network 141. Controller 131 includes memory 132, power source 133, data input/output 135, processor 137, and network connection 139. It is appreciated that all of the electronic devices depicted are coupled via a bus or the like. It is appreciated that head-mounted device 100 is just one embodiment of the devices contemplated by the present disclosure. One of skill in the art will appreciate that the teachings disclosed herein may also apply to a heads-up display for a car (e.g., the windshield), or airplane, or may even be built into a personal computing device (e.g., smartphone, or the like).

As shown, housing 121 is shaped to removably mount on a head of a user through use of strap 123 (which may be elastic, Velcro, plastic, or the like and wrap around the head of the user). Housing 121 may be formed from metal, plastic, glass, or the like. Display 101 is disposed in housing 121 and positioned to show images to a user when housing 121 is mounted on the head of the user. It is appreciated that display 101 may be built into housing 121, or may be able to removably attach to housing 121. For example, display 101 may be part of a smart phone that may be inserted into housing 121. In another or the same example, display 101 may include an light emitting diode display (LED), organic LED display, liquid crystal display, holographic display, or the like. In some examples, display 101 may be partially transparent (or not obscure all of the user's vision) in order to provide an augmented reality (AR) environment. It is appreciated that display 101 may be constructed so it is only positioned in front of a single eye of the user.

In the depicted example, controller 131 is coupled to display 101 and a sensor (see e.g., FIG. 1B sensor 151). Controller 131 includes logic that when executed by controller 131 causes head-mounted device 100 to perform operations including controlling the images shown on display 131. It is appreciated that controller 131 may be a separate computer from head-mounted device 100 or may be partially disposed in head-mounted device 100 (e.g., if display 100 includes a smart phone and the processor in the smart phone handles some or all of the processing). Moreover controller 131 may include a distributed system, for example controller 131 may receive instructions over the internet or from remote servers. In the depicted example, controller 131 is coupled to receive instructions from network 141 through network connection 139 (e.g., wireless receiver, Ethernet port, or the like). Controller 131 also includes processor 137 which may include a graphics processing unit (e.g., one or more graphics cards, a general purpose processor or the like). Processor 137 may be coupled to memory 132 such as RAM, ROM, hard disk, remote storage or the like. Data input/output 135 may output instructions from controller 131 to head-mounted device 100 through data connection 125 which may include an electrical cable or the like. In some examples, connection 125 could be wireless (e.g., Bluetooth or the like). Power source 133 is also included in controller 131 and may include a power supply (e.g., AC to DC converter) that plugs into a wall outlet, battery, inductive charging source, or the like.

FIG. 1B depicts a cross sectional view of the example head-mounted device 100 of FIG. 1A. As shown, head-mounted device 100 also includes lens optics 155, sensors 151, non-visible illuminators 153, and cushioning 157 (so head-mounted device 100 rests comfortably on the forehead of the user). In the depicted example, lens optics 155 (which may include one or more Fresnel lenses, convex lenses, concave lenses, or the like) are positioned in housing 121 between display 101 and the eyes of the user, to focus light from the images on display 101 into the eye of the user. Non-visible illuminators 153 (e.g., LEDs) are positioned in housing 121 to illuminate the eye with the non-visible light (e.g., infrared light or the like), and sensors 151 (e.g., CMOS image sensors or the like) are structured (e.g., with IR passing filters, narrow bandgap semiconductor materials like Ge/SiGe or the like) to absorb the non-visible light and monitor the gaze location of the eye. Thus, the eyes of the user are fully illuminated to sensors 151, but the user does not see any light other than the light from display 101.

In some examples, there may be only one sensor 151 or there may be a plurality of sensors 151, and sensors 151 are disposed in various places around lens optics 155 to monitor the eyes of the user. It is appreciated that sensors 151 may be positioned to image the eye through lens optics 155 or may image the eye without intermediary optics. It is also appreciated that the system may be calibrated in order to relate eye position to where the user is looking at on display 101. Calibration may occur at the factory or after purchase by the user.

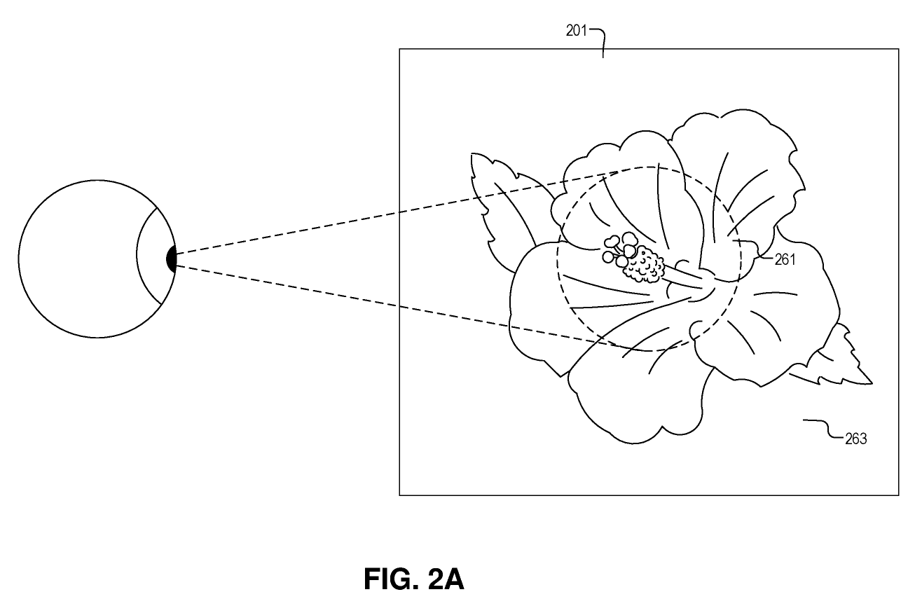

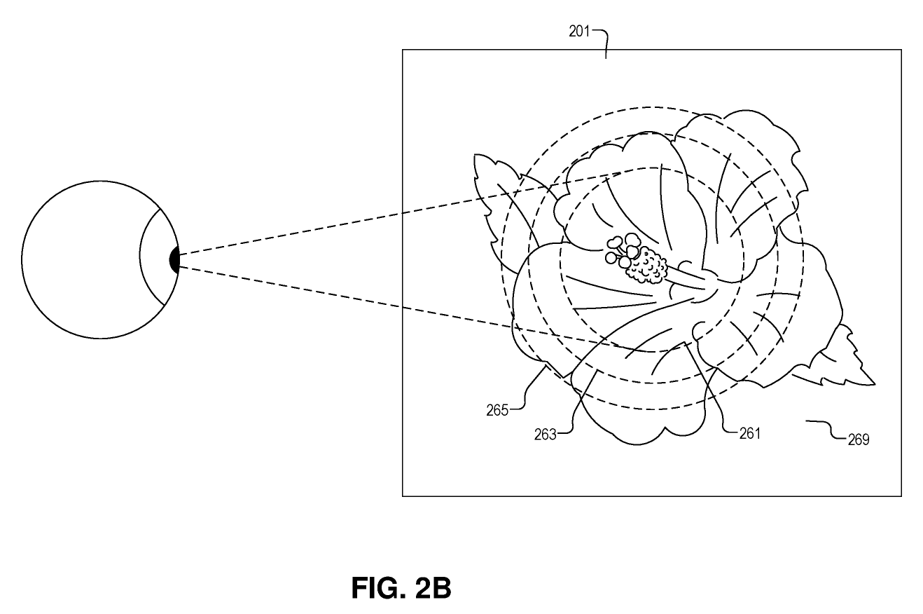

FIGS. 2A & 2B illustrate examples of providing image data to display 201 (e.g., display 101 of FIGS. 1A and 1B) in a manner that reduces the required bandwidth. For example, FIG. 2A shows outputting (to display 201) first resolution image data for a first region 261 in an image (here an image of a flower). It is appreciated that first region 261 includes the gaze location of the eye on the display. Put another way, first region 261 is the location on display 201 where the eye is looking. First region 261 changes location depending on where the eye is looking, and the image data transmitted to the display is changed accordingly (e.g., different resolution, frame rate, refresh rate, etc.). It is appreciated that since region 261 is where the eye sees most clearly, region 261 may be supplied with the highest resolution image data. Also shown is outputting (to display 201) second resolution image data for a second region 263 in the image. Second region 263 is in the peripheral vision of the eye; accordingly, the first resolution image data supplied to first region 261 has a higher resolution than the second resolution image data supplied to second region 263. Thus, less data needs to be transmitted to display 201 without worsening the user's experience of the head-mounted device. It is appreciated that in some examples, for regions outside of first region 261, 1 of X pixels may receive the image data from the controller, thus display 201 operates with functionally a 1/X resolution in this region. Put another way, only 1/X pixels may be updated with new information each refresh cycle.

FIG. 2B is similar to FIG. 2A but includes additional regions: third region 265 and fourth region 269. Thus, FIG. 2B includes a plurality of regions. In the depicted example, third resolution image data is output to the display 201 for third region 265 in the images. Second region 263 is disposed between first region 261 and third region 265, and the second resolution image data has a higher resolution than the third resolution image data. Accordingly, the resolution of the image is lower moving away from the center of the user's gaze. Similarly, fourth region 269 includes fourth resolution image data, which has a lower resolution than the third resolution image data.

It is appreciated that second region 263 is concentric with first region 261, and the second resolution image data decreases in resolution gradually from first region 261 to third region 265. Similarly, the resolution of third region 265 may gradually decrease towards fourth region 269. The second resolution image data and third resolution image data may decrease in resolution from the first region to the fourth region at a linear or non-linear rate.

In the same or a different example, the first resolution image data has a first frame rate, the second resolution image data has a second frame rate, the third resolution image data has a third frame rate, and the fourth resolution image has a fourth frame rate. And the first frame rate is greater than the second frame rate, the second frame rate is greater than the third frame rate, and the third frame rate is greater than the fourth frame rate. Reducing the frame rate in the peripheral region of the user's vision may further conserve bandwidth since less data needs to be transferred to display 201. It is appreciated that like resolution, the second frame rate may decrease gradually from first region 261 to the third region 265, and the third frame rate may decrease gradually from the second region 263 to fourth region 269.

In another or the same example, the first resolution image data may have a first refresh rate, the second resolution image data may have a second refresh rate, the third resolution image data may have a third refresh rate, and the fourth resolution image data my have a fourth refresh rate. And the first refresh rate is greater than the second refresh rate, the second refresh rate is greater than the third refresh rate, and the third refresh rate is greater than the fourth refresh rate. It is appreciated that the second refresh rate may decrease gradually from first region 261 to third region 265, and the third refresh rate may decrease gradually from second region 263 to fourth region 269. Like reducing the frame rate and resolution, reducing the refresh rate may similarly reduce the amount of data required in order to operate display 201.

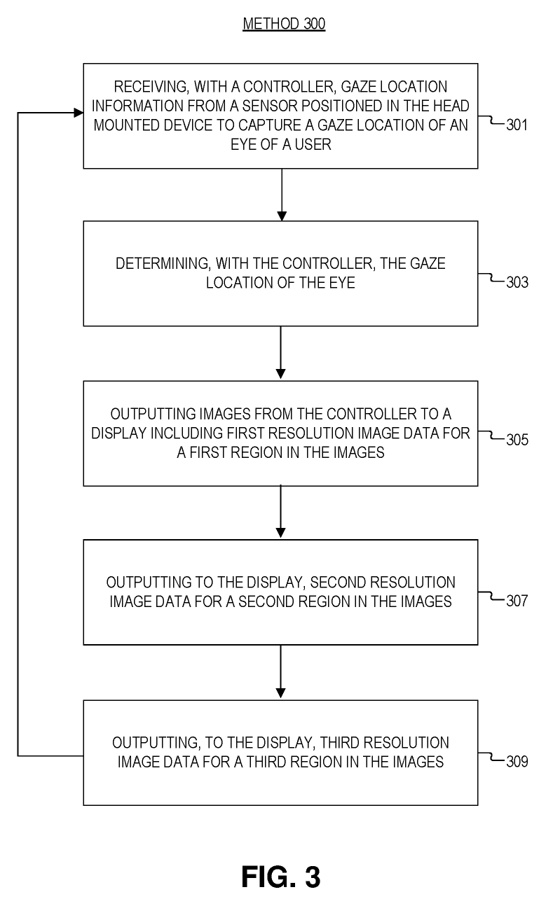

FIG. 3 shows an example method 300 of operating a head-mounted device. One of ordinary skill in the art will appreciate that blocks 301-309 in method 300 may occur in any order and even in parallel. Moreover, blocks can be added to or removed from method 300 in accordance with the teachings of the present disclosure.

Block 301 shows receiving, with a controller (e.g., controller 131 of FIG. 1A), gaze location information from a sensor (e.g., sensor 155 of FIG. 1B) positioned in the head-mounted device to capture a gaze location of an eye of a user. In some examples, capturing the gaze location of the eye includes capturing a location on the display that the eye is looking at. This may be a specific quadrant of the screen or groups of individual pixels on the screen.

Block 303 depicts determining, with the controller, the gaze location of the eye. In some examples this may include correlating the position of the user's iris or pupil with where the user is looking on the screen. This may be achieved by calibrating the system in a factory, or having the user calibrate the head-mounted display before they use it. Additionally, head-mounted display may iteratively learn where the user is looking using a machine learning algorithm (e.g., neural net) or the like.

Block 305 illustrates outputting images (e.g., video, video game graphics or the like) from the controller (which may be disposed in a PC or gaming system) to a display including first resolution image data for a first region in the images. It is appreciated that the first region includes the gaze location of the eye on the display (e.g., the place on the display where the eye is looking).

Block 307 shows outputting to the display, second resolution image data for a second region in the images. The first resolution image data has a higher resolution (e.g., 1080 p) than the second resolution image data (e.g., 720 p or less). In some examples, the second region is concentric with the first region. In some examples the regions may not have the same center and may have a predetermined amount of offset from one another.

Block 309 depicts outputting, to the display, third resolution image data for a third region in the images. In the depicted example, the second region is disposed between the first region and the third region, and the second resolution image data has a higher resolution than the third resolution image data. The second resolution image data may decrease in resolution gradually from the first region to the third region (e.g., linearly, exponentially, degreasing at a decreasing rate, decreasing at an increasing rate, or the like).

In some examples, it is appreciated that the various regions of the images may have varying frame rates. In one example, the first resolution image data has a first frame rate, the second resolution image data has a second frame rate, and the third resolution image data has a third frame rate. And the first frame rate is greater than the second frame rate, and the second frame rate is greater than the third frame rate. It is appreciated that, like the resolution, frame rate may decrease gradually from the first region to the third region (e.g., linearly, exponentially, degreasing at a decreasing rate, decreasing at an increasing rate, or the like). It is appreciated that in some examples, the frame rates of all the pixels in all of the regions are aligned. Put another way, although the pixels in the different regions have different frame rates, they receive new image data transferred from the controller at the same time. For example, a pixel in the first region may receive image data from the controller at 120 Hz, while a pixel in the second region may receive image data from the controller at 60 Hz; both pixels would update when the second (slower) pixel updated. Thus, the first frame rate is an integer multiple of the second frame rate. In other embodiments, and the second frame rate may be an integer multiple of the third frame rate.

In some examples, it is appreciated that the various regions of the images may have varying refresh rates. In the depicted example, the first resolution image data has a first refresh rate, the second resolution image data has a second refresh rate, and the third resolution image data has a third refresh rate. And the first refresh rate is greater than the second refresh rate, and the second refresh rate is greater than the third refresh rate. In some examples, the second refresh rate decreases gradually from the first region to the third region (e.g., linearly, exponentially, degreasing at a decreasing rate, decreasing at an increasing rate, or the like). It is appreciated that in some examples, the refresh period of all the pixels in all of the regions is aligned. For example, the pixels in the first region may refresh at a rate of 240 Hz, while the pixels in the second region refresh at 120 Hz, thus the pixels in the two different regions refresh at the same time but with different periods. Accordingly, the first refresh rate is an integer multiple of the second refresh rate. In other embodiments, the second refresh rate may be an integer multiple of the third refresh rate.

In one example, the display is initiated by a first frame with full resolution across the entire display (e.g., at both the eye focus regions and out of eye focus regions). This way user experience is not degraded before gaze location calculations are performed. Additionally, one of skill in the art will appreciate that “frame rate” refers to the frequency of the image data, while “refresh rate” refers to the refresh rate of the pixels in the display, and that these rates may be different.

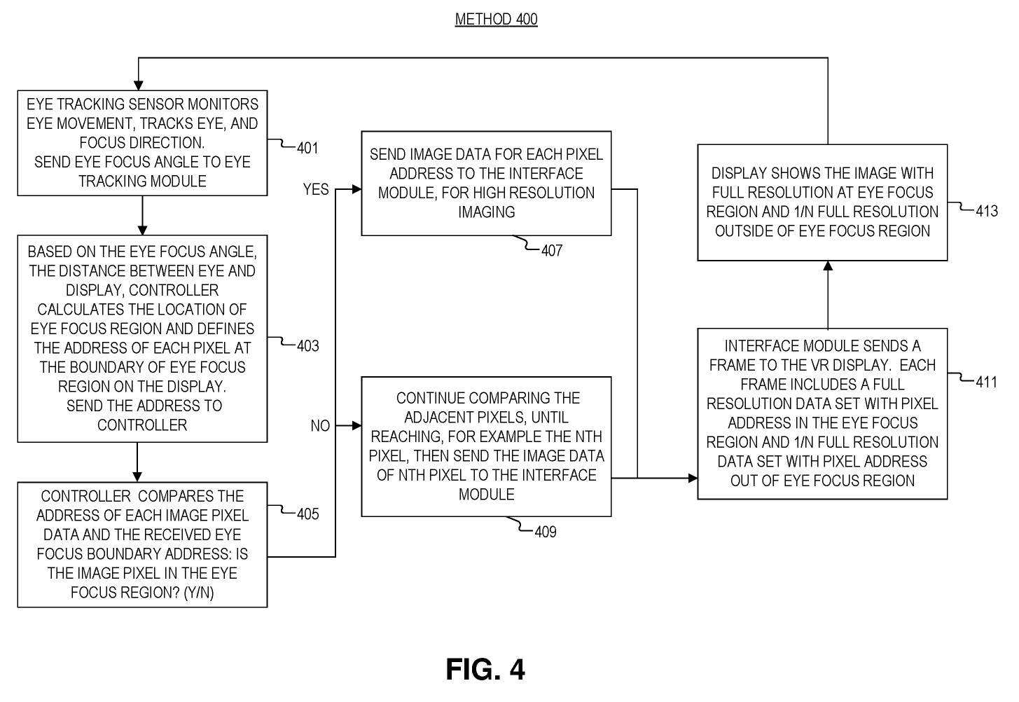

FIG. 4 shows an example method 400 of operating a head-mounted device. It is appreciated that FIG. 4 may depict a more specific example of the method shown in FIG. 3. One of ordinary skill in the art will appreciate that blocks 401-413 in method 400 may occur in any order and even in parallel. Moreover, blocks can be added to or removed from method 400 in accordance with the teachings of the present disclosure.

Block 401 shows tracking eye movement with the sensor (which may include tracking eye focus direction, location on the display, angle of gaze, etc.). This information may then be sent to an eye tracking module (e.g., a component in the controller which may be implemented in hardware, software, or a combination of the two), to track the gaze location of the eye.

Block 403 depicts calculating the gaze location (e.g., based on the eye focus angle, and the distance between the eye and the display) and defining the address of each pixel at the boundary of the eye focus region (e.g., gaze location) on the display. These addresses are then sent to the controller. It is appreciated that the processor or control circuitry disposed in the head-mounted device may be considered part of the “controller”, in accordance with the teachings of the disclosure.

Block 405 illustrates comparing the address of image pixel data and the received eye focus boundary address with the controller. As shown, the controller determines if the image pixel is in the eye focus region.

Block 407 shows that, if the image pixel is in the eye focus region, then the image data for each pixel address is sent to the interface module (e.g., another component in the controller which may be implemented in hardware, software, or a combination thereof) for high resolution imaging.

Block 409 depicts that if the image pixel is not in the eye focus region, the system continues comparing the adjacent pixels, until it reaches the N^{th} pixel (e.g., the 10^{th} pixel), then the system only sends the image data of the N^{th} (e.g., 10^{th}) pixel to the interface module. Accordingly, the data set may be greatly reduced. In some examples, the N^{th} pixel could be more pixels or less pixels than the 10^{th}. One of skill in the art will appreciate that other methods may also be used to reduce the data set for partial low resolution imaging.

Block 411 illustrates that the interface module sends a frame to the VR display via wireless or wired connection. Each frame includes a full resolution data set with a pixel address in the eye focus region and a 1/N (e.g., 1/10) full resolution data set for pixel addresses out of the eye focus region. This effectively reduces the bandwidth needed to provide the image data from the controller (e.g., controller 131 of FIG. 1A) to VR headset display.

Block 413 shows displaying (e.g., on display 101) the image with full resolution at eye focus region and 1/N full resolution outside of eye focus region.

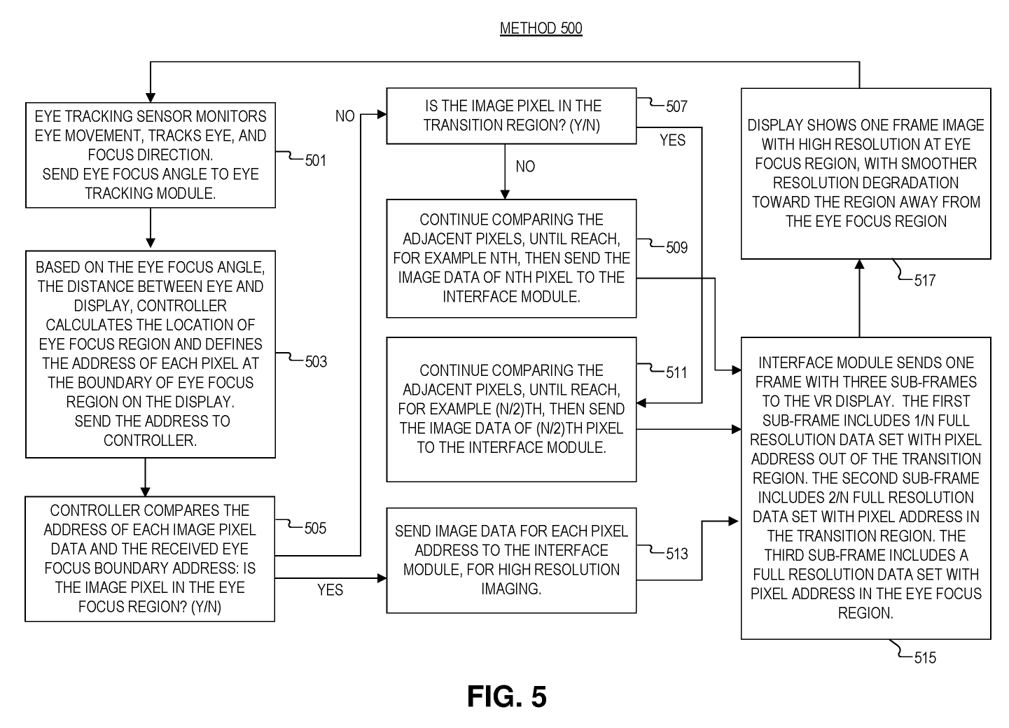

FIG. 5 shows an example method 500 of operating a head-mounted device. It is appreciated that FIG. 5 may depict a different, but similar, method than the method depicted in FIG. 4. One of ordinary skill in the art will appreciate that blocks 501-517 in method 500 may occur in any order and even in parallel. Moreover, blocks can be added to or removed from method 500 in accordance with the teachings of the present disclosure.

Block 501-block 505 depict similar actions as blocks 401-405 in method 400 of FIG. 4.

Block 507 shows the system determining if an image pixel is in a transition region if the pixel is not in the eye focus region.

Block 509 shows that if the image pixel is not determined to be in the transition region, the system continues comparing the adjacent pixels, until the system reaches the N^{th} pixel (e.g., the 10^{th} pixel), then the system sends the image data of the N^{th} pixel to the interface module.

Block 511 shows that if the image pixel is determined to be in the transition region, the system continues comparing the adjacent pixels, until the system reaches the (N/2)^{th} pixel (e.g., the 5^{th} pixel) then the system sends the image data of (N/2)^{th} pixel to the interface module.

Block 513 shows that if the image pixel is in the eye focus region (see block 505), then image data for each pixel address is sent to the interface module for high resolution imaging.

Block 515 illustrates sending one frame with three sub-frames to the VR display (via wireless or wired connection) with the interface module. The first sub-frame may include a 1/N (e.g., 1/10) full resolution data set, with pixel addresses out of the transition region. The second sub-frame may include 2/N (e.g., 1/5) full resolution data set with pixel address in the transition region. The third sub-frame may include a full resolution data set with pixel address in the eye focus region. Thus, the bandwidth needed to provide the image data from controller to VR headset display is greatly reduced.

Block 517 depicts displaying one frame image with a high resolution at the eye focus region with smoother resolution degradation toward the region away from the gaze location, without perceptible loss in image quality.

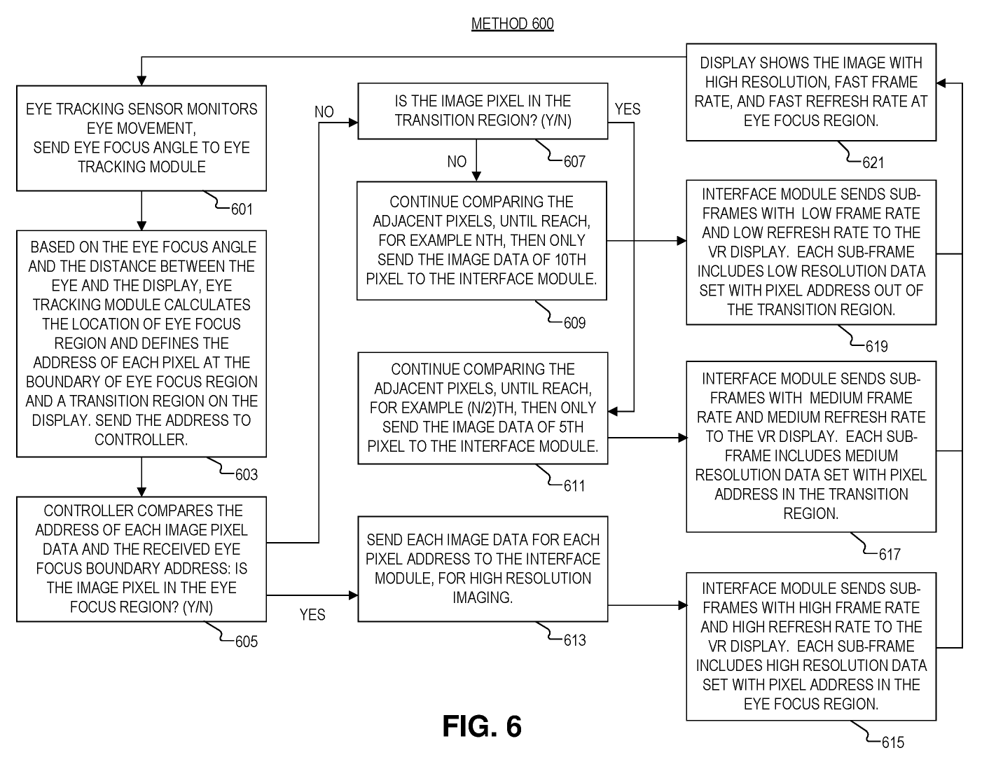

FIG. 6 shows an example method 600 of operating a head-mounted device. It is appreciated that FIG. 6 may depict a different, but similar, method than the method depicted in FIG. 5. One of ordinary skill in the art will appreciate that blocks 601-621 in method 600 may occur in any order and even in parallel. Moreover, blocks can be added to or removed from method 600 in accordance with the teachings of the present disclosure.

Block 601 shows the system using a sensor (e.g., sensor 155) to monitor eye movement, and send the eye focus angle to an eye tracking module.

Block 603 illustrates the eye tracking module in the system calculating (based on the eye focus angle and the distance between the eye and the display) the gaze location of the eye, and defining the address of each pixel at the boundary of eye focus region and a transition region on the display. This address may then be sent to the VR controller.

Block 605 depicts using the controller to compare the address of the image pixel data and the received eye focus boundary address.

Block 607 shows the system determining if the image pixel is in the transition region, if the image pixel was not in the eye focus region.

Block 609 illustrates if the image pixel is not in the transition region, then the system continues to compare the adjacent pixels, until it reaches the N^{th} pixel (e.g., the 10^{th} pixel), then the system sends the image data of N^{th} pixel to the interface module.

Block 611 depicts if the image pixel is in the transition region, the system continues comparing the adjacent pixels, until it reaches the (N/2)^{th} pixel (e.g., the 5^{th} pixel), then the system sends the image data of (N/2)^{th} pixel to the interface module.

Block 613 shows if the image pixel is in the eye focus region, the system sends image data for each pixel address to the interface module, for high resolution imaging.

Block 615 illustrates the interface module sending sub-frames with a high frame rate and high refresh rate to the VR display via a wireless or wired connection. Each sub-frame includes high resolution data set with pixel addresses in the eye focus region.

Block 617 depicts the interface module sending sub-frames with a medium frame rate and medium refresh rate to the VR display via a wireless or wired connection. Each sub-frame includes medium resolution data set with pixel addresses in the transition region.

Block 619 shows the interface module sending sub-frames with a low frame rate and a low refresh rate to the VR display via a wireless or wired connection. Each sub-frame includes a low resolution data set with a pixel addresses out of the transition region.

Block 621 illustrates displaying the image with high resolution, fast frame rate and fast refresh rate at eye focus region, without perceptible lose in image quality.

The above description of illustrated examples of the invention, including what is described in the Abstract, is not intended to be exhaustive or to limit the invention to the precise forms disclosed. While specific examples of the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific examples disclosed in the specification. Rather, the scope of the invention is to be determined entirely by the following claims, which are to be construed in accordance with established doctrines of claim interpretation.

What is claimed is:

1. A display system, comprising:
a display positioned to show images to a user;
a sensor positioned to monitor a gaze location of an eye of the user and output gaze location information; and
a controller coupled to the display and the sensor, wherein the controller includes logic that when executed by the controller causes the display system to perform operations, including:
receiving, with the controller, the gaze location information from the sensor;
determining, with the controller, the gaze location of the eye;
outputting, to the display, first resolution image data for a first region in the images, wherein the first region includes the gaze location of the eye on the display;
outputting, to the display, second resolution image data for a second region in the images, wherein the first resolution image data has a higher resolution than the second resolution image data; and
outputting, to the display, third resolution image data for a third region in the images, wherein the second region is disposed between the first region and the third region, and wherein the second resolution image data has a higher resolution than the third resolution image data.

2. The device of claim 1, further comprising:
a housing shaped to removably mount on a head of a user, and wherein the display is structured to be disposed in the housing when the housing is mounted on the head of the user, and wherein the sensor is positioned in the housing to monitor a gaze location of the eye when the housing is mounted on the head of the user.

3. The device of claim 1, wherein the second region is concentric with the first region, and wherein the second resolution image data decreases in resolution gradually from the first region to the third region.

4. The device of claim 3, wherein the second resolution image data decreases in resolution from the first region to the third region at a linear or non-linear rate.

5. The device of claim 1, wherein the first resolution image data has a first frame rate, the second resolution image data has a second frame rate, and the third resolution image data has a third frame rate, and wherein the first frame rate is greater than the second frame rate, and the second frame rate is greater than the third frame rate.

6. The device of claim 5, wherein the second frame rate decreases gradually from the first region to the third region.

7. The device of claim 1, wherein the first resolution image data has a first refresh rate, the second resolution image data has a second refresh rate, and the third resolution image data has a third refresh rate, and wherein the first refresh rate is greater than the second refresh rate, and the second refresh rate is greater than the third refresh rate.

8. The device of claim 7, wherein the second refresh rate decreases gradually from the first region to the third region.

9. A head-mounted apparatus, comprising:
a housing shaped to mount on the head of a user;
a display positioned to show images to the user when the housing is mounted on the head of the user;
a sensor positioned in the housing to monitor a gaze location of an eye of the user, when the housing is mounted on the head of the user, and output gaze location information; and
a controller coupled to the display and the sensor, wherein the controller includes logic that when executed by the controller causes the head-mounted apparatus to perform operations, including:
receiving, with the controller, the gaze location information from the sensor;
determining, with the controller, the gaze location of the eye;
outputting, to the display, first resolution image data for a first region in the images, wherein the first region includes the gaze location of the eye on the display;
outputting, to the display, second resolution image data for a second region in the images, wherein the first resolution image data has a higher resolution than the second resolution image data; and
outputting, to the display, third resolution image data for a third region in the images, wherein the second region is disposed between the first region and the third region, and wherein the second resolution image data has a higher resolution than the third resolution image data.

10. The head-mounted apparatus of claim 9, further comprising:
lens optics positioned in the housing between the display and the eye to focus light from the images on the display into the eye; and
non-visible illuminators positioned in the housing to illuminate the eye with the non-visible light, wherein the sensor is structured to absorb the non-visible light to monitor the gaze location of the eye.

11. The head-mounted apparatus of claim 9, wherein the first resolution image data has a first frame rate, the second resolution image data has a second frame rate, and the third resolution image data has a third frame rate, and wherein the first frame rate is greater than the second frame rate, and the second frame rate is greater than the third frame rate.

12. The head-mounted apparatus of claim 9, wherein the first resolution image data has a first refresh rate, the second resolution image data has a second refresh rate, and the third resolution image data has a third refresh rate, and wherein the first refresh rate is greater than the second refresh rate, and the second refresh rate is greater than the third refresh rate.

13. A method, comprising:
receiving, with a controller, gaze location information from a sensor to capture a gaze location of an eye of a user;
determining, with the controller, the gaze location of the eye;
outputting images from the controller to a display including first resolution image data for a first region in the images, wherein the first region includes the gaze location of the eye on the display; and
outputting to the display, second resolution image data for a second region in the images, wherein the first resolution image data has a higher resolution than the second resolution image data; and
outputting, to the display, third resolution image data for a third region in the images, wherein the second region is disposed between the first region and the third region, and wherein the second resolution image data has a higher resolution than the third resolution image data.

14. The method of claim 13, wherein the second region is concentric with the first region, and wherein the second resolution image data decreases in resolution gradually from the first region to the third region.

15. The method of claim 14, wherein the second resolution image data decreases from the first region to the third region by one of a linear rate, a decreasing rate, or an increasing rate.

16. The method of claim 13, wherein the first resolution image data has a first frame rate, the second resolution image data has a second frame rate, and the third resolution image data has a third frame rate, and wherein the first frame rate is greater than the second frame rate, and the second frame rate is greater than the third frame rate.

17. The method of claim 16, wherein the second frame rate decreases gradually from the first region to the third region.

18. The method of claim 16, wherein the first frame rate is an integer multiple of the second frame rate, and the second frame rate is an integer multiple of the third frame rate.

19. The method of claim 13, wherein the first resolution image data has a first refresh rate, the second resolution image data has a second refresh rate, and the third resolution image data has a third refresh rate, and wherein the first refresh rate is greater than the second refresh rate, and the second refresh rate is greater than the third refresh rate.

20. The method of claim 19, wherein the second refresh rate decreases gradually from the first region to the third region.

21. The method of claim 19, wherein the first refresh rate is an integer multiple of the second refresh rate, and the second refresh rate is an integer multiple of the third refresh rate.

22. The method of claim 13, wherein capturing the gaze location of the eye includes capturing a location on the display that the eye is looking at, and wherein the display is disposed in a head-mounted device.
